(19) United States
(12) Patent Application Publication
(10) Pub. No.: US 2002/0167542 A1
(43) Pub. Date: Nov. 14, 2002

(54) Method for capturing demographic information from a skinable software application

(76) Inventor: Bradley J. Florin, St. Petersburg, FL (US)

Correspondence Address: SMITH & HOPEN PA, 15950 BAY VISTA DRIVE, SUITE 220, CLEARWATER, FL, 33760

(21) Appl. No.: 09/681,632

(22) Filed: May 14, 2001

(51) Int. Cl. G06F 3/00; G06F 13/00

(52) U.S. Cl. 345/745; 345/753

(57) ABSTRACT

A method of obtaining demographic information relating to the use of a distributable skin, the method including the steps of establishing a demographic data store, retrieving an array of demographic information responsive to the registration of a skinable client-side application, storing the array in the data store, responsive to a use of the skin on the application, establishing a data connection between the data store and the application, and updating the array to reflect the use of the skin.

### BACKGROUND OF INVENTION

1. Field of Invention

This invention relates to a method for capturing demographic information, and more particularly, a method for embedding demographic information into a distributable graphic user interfaces and retrieving data relating to their use.

2. Background of the Invention

In the software industry, a skin is known to be a collection of graphic and audio files that determine how a user interface is going to look and sound. If a software application is “skinable” it means that a plurality of different graphic interfaces may be applied to the look and feel of the application. The ability to change the look and feel of a graphic user interface is also sometimes known as a “theme.” One of the earliest embodiments of a skin-type application was the screen saver. If cathode ray tubes (CRTs) displayed the same image or text for an extended period of time, the phosphor-coated screen would “burn-in” the static image or text. Accordingly, screen savers displayed an animated image in response to a period of no user activity. Users often configured their individual computers to display screen savers that reflected a personal interest. Although modern CRT display technology makes burn-in unlikely except under extreme conditions, screen savers are still a popular means for computer users to visibly express their individuality and interests on their computers.

Many users of the Microsoft Windows® operating system, produced by Microsoft Corporation based in Redmond, Wash., are aware that the background color of the operating system (“the desktop”) may be replaced with alternative colors, photographs, patterns, and even dynamic content. Accordingly, while the basic functionality of the operating system remained unaffected, each user could express their individual identity.

Skinable applications such as the NeoPlanet web browser produced by NeoPlanet, Inc. based in Tempe, Ariz. have a substantial base of users and skin authors. As of May,

2001, nearly 600 different skins were available on the NeoPlanet website ranging from “gothic” to “sci-fi” to “cartoons.” Another skinable application is the WinAmp music player produced by Nullsoft, Inc., which was purchased by American Online (now AOL Time Warner). The website for the WinAmp product claims over 32,000 skins are currently available. Still other applications that are skinable include Microsoft Windows Media Player version 7, Netscape Navigator 6.0, RealPlayer, RealjukeBox, and Quake.

Because of the personal nature of skins and large variety of subject matter available to end users, important demographic information may be obtained simply by knowing what type of skin an end user enables on an application. For example, some users may have a strong interest in professional football, collecting antiques, opera, or travel. Promoting products and services appropriate to each interest area is the core objective of business demographics. However, in the prior art, demographic services have required end users to submit detailed information about themselves. With an increasing desire to maintain one's online privacy, many users are now hesitant to provide such detailed information for the fear it may be misused.

Accordingly, what is needed in the art is a method of associating a demographic profile with an application skin and delivering product and service promotions based on the profile.

Another need in the art is a method of delivering demographically targeted promotions while providing a greater degree of end user anonymity. It is, therefore, to the effective resolution of the aforementioned problems and shortcomings of the prior art that the present invention is directed.

However, in view of the prior art in at the time the present invention was made, it was not obvious to those of ordinary skill in the pertinent art how the identified needs could be fulfilled.

### SUMMARY OF INVENTION

The present invention comprises a method of obtaining demographic information relating to the use of a distributable skin. A demographic data store is first established. Data stores are often embodied as commercially available database applications such as those available from Microsoft, Oracle, IBM, Informix and the like. An array of demographic information is retrieved responsive to the registration of a skinable client-side application. The array comprises variables well known to the demographic field such as age, location, interests, spending habits, profession, gender and the like. The array is stored in the data store. Responsive to a use of the skin on the application a data connection between the data store and the application is established and the array is updated to reflect the use of the skin.

The quality of demographic information, much like the general field of statistics, gains its strength in numbers. Accordingly, the novel invention includes the step of aggregating a plurality of arrays which reflect the use of the skin and resolving a common demographic profile associated with the skin. As known demographic profiles are associated with the skin, such profiles may be directly attributed to the skin itself. Accordingly, statistically-based assumptions may be made about an anonymous user of a particular skin based on data obtained from a population of known users. For example, a skin may contain graphic elements and content associated with a movie feature which is statistically shown to be popular with women ages 35 to 55 years old. In the absence of registration information or other identity data, the mere fact that a user has enabled the movie feature skin is valuable data for demographic purposes. Demographically targeted content may be sent to the application or to a web browser responsive to the use of the skin, even if only the identity of the enabled skin is known. Such content may include suggested URLs, advertisements, news stories, surveys, sweepstakes offer and the like. The transmission technology can be push technology in the case of a client application and pull technology in the case a web browser, both typically occurring over a TCP/IP connection from a content server to the application or browser.

Another novel aspect of the present invention is the ability to connect a plurality of users with common interests for online collaboration and interaction based on the usage of a skin. The steps include establishing a conference system, the system having a plurality of conference areas, establishing a conference feature communicatively coupled to the application, associating at least one predetermined conference area with the use of the skin, and defaulting to the at least one predetermined conference area responsive to an execution of the conference feature and the use of the skin. The conference feature may include text-based communication, audio-based communication, video-based communication or combinations thereof. Alternatively, the target collaboration group could be based on a skin, as written, or it could also be based on a published target demographic. For example, “I want to chat with other technology minded entrepreneurs ages 30 to 40”.

Online privacy is an increasing concern and a top priority to many users. Unless persuasive incentives exist, many users opt out of providing demographic information for fear the information may be misused. The current invention provides a novel means of providing meaningful information directed towards a demographic profile while permitting the user to remain substantially anonymous. The method includes establishing a demographic data store, retrieving an anonymous identifier responsive to the registration of a skinable client-side application, storing the anonymous identifier in the data store, responsive to a use of the skin on the application, establishing a data connection between the data store and the application, and updating the anonymous identifier to reflect the use of the skin. In a preferred embodiment of the invention, additional steps include predefining a demographic profile for the skin based on the aesthetic qualities of the skin and associating the demographic profile with the anonymous identifier.

Preemptive demographic targeting of the skins may be achieved during the authoring process by establishing a predetermined specification for arranging an array of content media encapsulated within the skin, establishing an intended demographic target of the skin based on the array of content media, associating a remotely retrievable identifier with the intended demographic target and storing the identifier in the skin. Intellectual property rights data may be embedding into the skin according to existing digital rights management methods.

An alternative embodiment of the invention provides the ability to monitor and report the usage of skins on third-party applications such as WinAmp or NeoPlanet.

The embodiment comprises the steps of establishing a client-side skin monitoring application adapted to detect the presence of at least one skin on a client-side computing device. The client-side skin monitoring application may include its own functionality and may integrate skins into its GUI. Alternatively, the monitoring application may take a more passive role only monitoring the use of skins by other applications. A demographic data store is established and communicatively coupled to the client-side skin monitoring application, typically through a TCP/IP connection over a network. The client-side skin monitoring application establishes an identity of at least one skin on the client-side computing device and transmits the identity of the at least one skin to the demographic data store. The client-side skin monitoring application may detect the use of a skin by monitoring internal operating system messaging or may scan at least one client-side storage device to detect the presence of at least one skin. Such storage device would typically comprise the local hard drive or other magnetic media. An array of file directories may be preselected to increase the efficiency of the scanning process. It is therefore an object of the present invention to provide a method of resolving information about a software application user based on the skin selected by the user and applied to the software application.

It is another object of the present invention to provide a method of targeting information for delivery to a software application user based on the skin selected by the user and applied to the software application.

It is another object of the present invention to provide a method of targeting information for delivery to a software application user while substantially preserving the anonymity of the user.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a flow chart diagram illustrating the invention generally.

FIG. 2 is a flow chart diagram illustrating the application of the demographic data store.

FIG. 3 is a flow chart diagram of the authoring process for a demographically targeted skin.

FIG. 4 is a flow chart diagram of an anonymous user embodiment of the invention.

FIG. 5 is a flow chart diagram of a survey process according to the invention.

FIG. 6 is a flow chart diagram of an aggregation of user profiles used to resolve an aggregate profile for at least one skin.

FIG. 7 is a flow chart diagram of an embodiment of the invention wherein third-party skinable applications are monitored and the results transmitted to the demographic data store.

FIG. 8 is a flow chart diagram of the invention illustrating the delivery of demographically targeted information back to the application.

### DETAILED DESCRIPTION

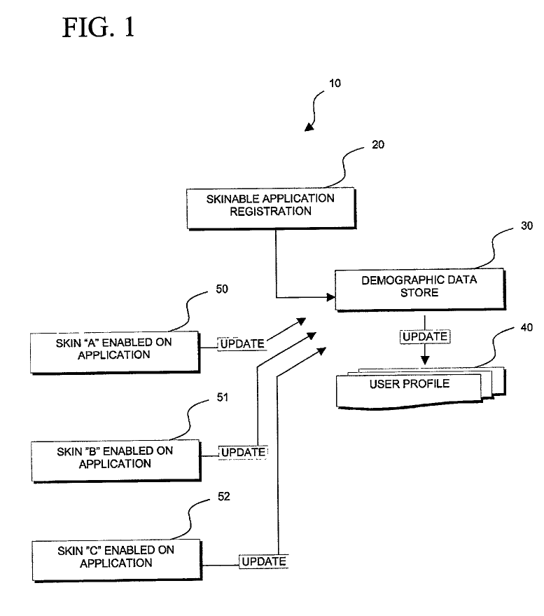

FIG. 1 shows the invention indicated generally as 10. A skinable application is downloaded onto a client-display device and a registration process 20 provides preliminary demographic data to a demographic data store 30. The preliminary demographic data may include, but is not limited to, age, occupation, interests, geographic location, gender and the like. A plurality of skins, Skins A-C (50-52) are each enabled on the skinable application and the identity of each skin is transmitted to the demographic data store 30. The user profile 40 is accordingly updated to reflect the use of a particular skin. For example, Skin A 50 may contain Hawaiian graphics and audio. The identity of Skin A 50 is then transmitted to the demographic data store 30 and the user profile 40 is updated to indicate that the end user may have an interest in traveling or learning more about the Hawaii islands. The demographic data store 30 would then be used to deliver discounted air fares, travel packages, or books on traveling to Hawaii through the application interface.

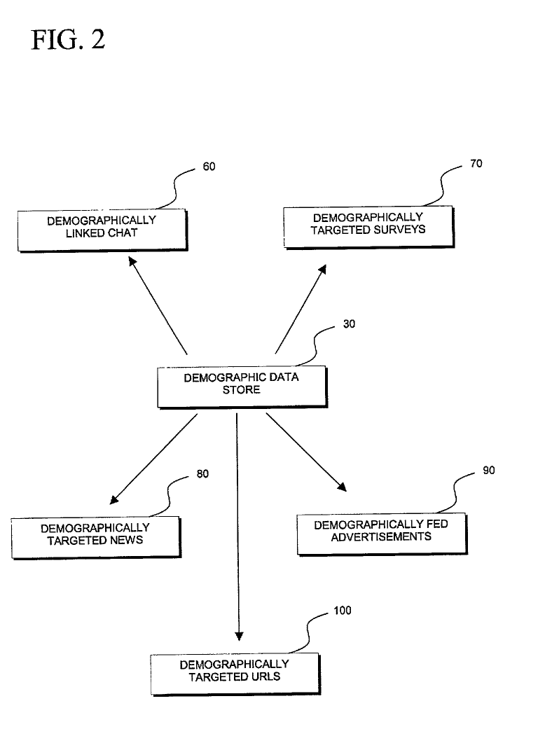

As indicated in FIG. 2, the demographic data store 30 may be tapped for a number of purposes included demographically linked chat 60, demographically targeted surveys 70, demographically targeted news 80, demographically fed advertisements 90 and demographically targeted URLs 100. For example, the application could either link to an external chat application or have an embedded chat feature which automatically places the end user into a chat or discussion group about Hawaiian culture or travel. The information may also be used to link to message boards consistent with the demographic of the user. The user may be presented with a survey about when they would most like to travel to Hawaii. News including, weather conditions may be sent to the user so they know what temperature it would be in Hawaii if they were presently there. Hotels in Hawaii might feed advertisements and specials to the end user in hopes the user will select their hotel for a Hawaiian vacation. Airlines might also advertise their low fares to Hawaii. The application may also provide URLs to Hawaiian history, activities, culture, tourism and the like. Accordingly, by only considering the type of skin enabled by the user, a host of appropriate information may be presented to the user.

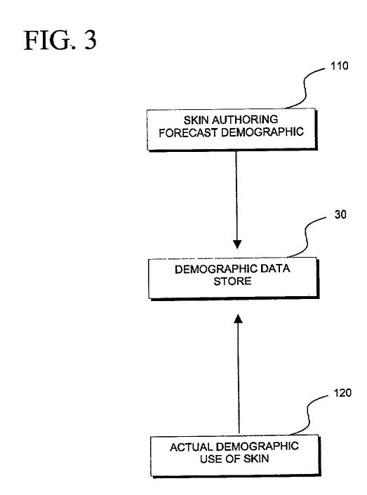

FIG. 3 illustrates the generation of a demographically targeted skin. A skin authoring process 110 forecasts the demographic target of the skin and the target information is stored in the demographic data store 30. As actual use of the demographic skin 120 is monitored, the demographic data store 30 is updated. For example, a skin author might create a Hawaiian island skin by aggregating a collection of Hawaiian images and the sounds of the surf. The author might anticipate that current residents of Hawaii might enjoy and use the skin and the demographic target is forecasted 110 to be residents of Hawaii living along the coast. The data relating to the Hawaiian skin is then stored in the demographic data store 30. However, actual use of the skin 120 reveals that non-residents of Hawaii were far more likely to use the skin as they possibly have a strong desire to visit, never before seeing such scenery or hearing the sounds of the surf. Accordingly, the demographic data store 30 is updated to more actually reflect such empirical data.

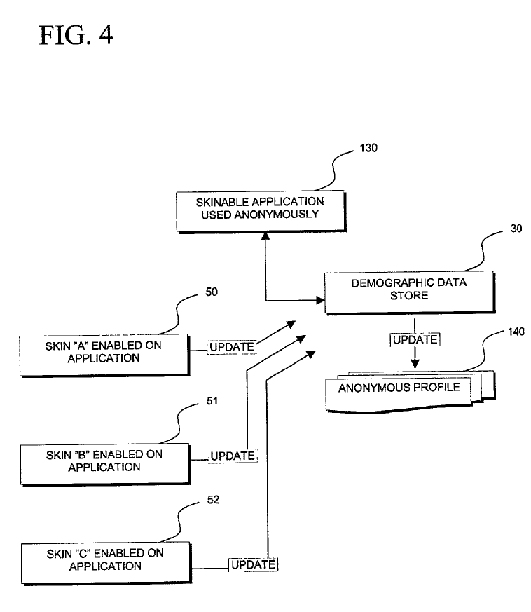

FIG. 4 illustrates an embodiment of the invention that permits the end user to remain substantially anonymous while still benefiting from demographically targeted information. Instead of submitting demographic information during a registration process, the skinable application is used anonymously 130 wherein only the application has a unique identity which is recorded in the demographic data store 30. As available skins 50-52 are enabled on the application, an anonymous profile 140 is updated to reflect such use and targeted information may be pushed back to the application 130. As more skins are enabled on the anonymous application, a more accurate anonymous profile 140 may be generated. For example, if the anonymous user repeatedly utilizes skins that contain content associated with science fiction movies, the anonymous user might be a good candidate to purchase science fiction videos from an online video retailer. Alternatively, if the anonymous user repeatedly utilizes skins that contain images of sports cars, demographically targeted information may include offers for car magazines, auto parts, or the like. Businesses obtain the benefit of targeting their messages to the appropriate consumer, the application user receives information more appropriate to his or her current interests as well as remaining anonymous.

It should be noted that a demographic profile describes “typical” customer or user. It does not mean that all customers or users fit a profile, but most would fit within the profile. Users of a skin for auto racing with pictures of fast cars, checkered flags, etc. may over time be determined using the statistical methods described to have an average annual household income of $75,430, be males aged 25 to 40 and be homeowners. Now, a company marketing a new razor want to target males 21 to 35 with a high disposable income. Users of the auto racing skin would be a good target demographic for them since the demographic profile is closely aligned with their target marketing profile. Thus, the product being sold is completely unrelated to the demographic profile built for the users of a skin. Accordingly, a luxury car company announcing a new vehicle looking for targets 35 to 50 years old with an average annual household income of $90,500 might also seek the same group of individuals that would likely travel to Hawaii as discussed above.

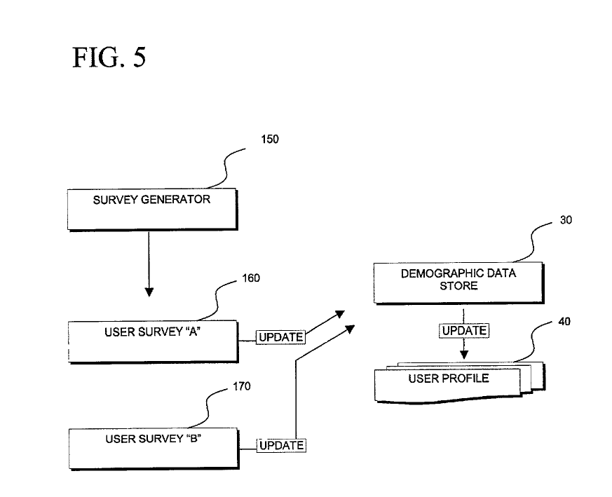

In FIG. 5, a survey generator 150 transmits User Survey “A” 760 and User Survey “B” 170 to the skinable application. Responses to the surveys update the information in the demographic data store 30 and the individual user profile 40. In a preferred embodiment of the invention, the survey generator 750 is communicatively linked to an incentive program wherein end user that complete a survey are rewarded through a sweepstakes program or with “points” which accumulate and are redeemable for merchandise, travel or the like.

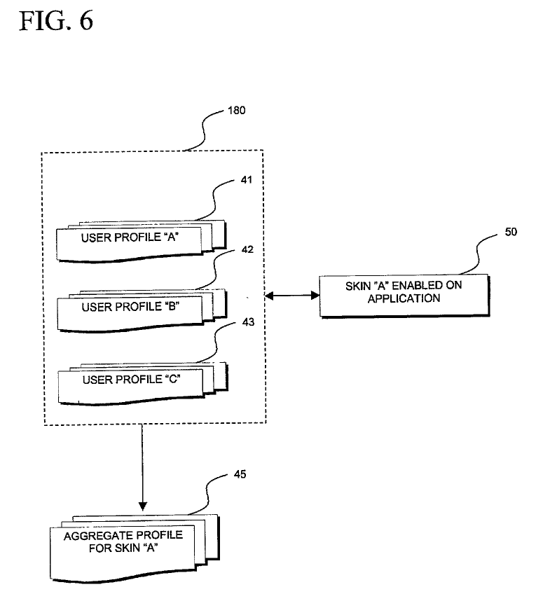

In FIG. 6, an aggregate 780 plurality of user profiles 41-43 are combined based on the use of a common skin 50. The resultant aggregate profile 45 may be associated with the skin 50 as statistically representative of the skin's demographic profile.

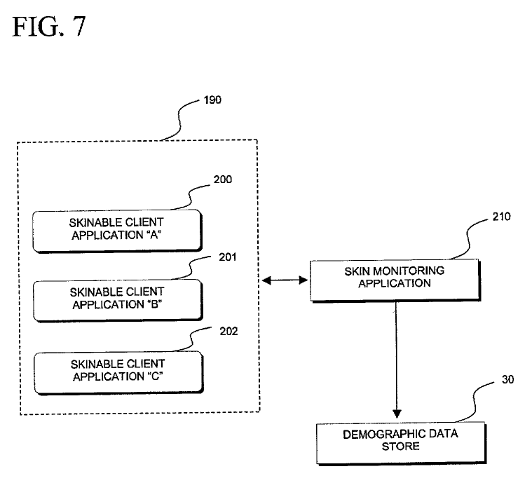

In FIG. 7, an array of third-party applications 190 is monitored by a skin monitoring application 210 to update the demographic data store 30. For example, the skin monitoring application 210 may tap into an internal API messaging pathway to determine which skins are used on a plurality of third-party applications 200-202. Such third-party applications may include the NeoPlanet web browser, the WinAmp music player, or the like.

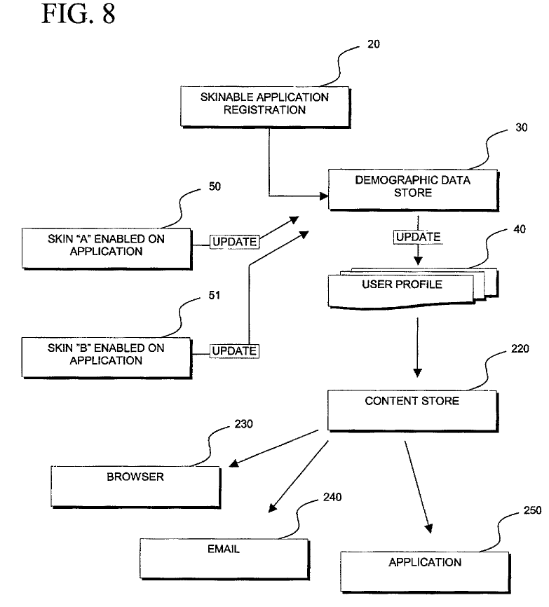

In FIG. 8, information in the user profile 40 is accessed by a content store 220 to deliver demographically targeted information by a plurality of means which may include transmission to the application 250, messaging to an email client 240, pushing information to a browser 230 or the like.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A method of obtaining demographic information relating to the use of a distributable skin, the method comprising the steps of:
establishing a demographic data store;
retrieving an array of demographic information responsive to the registration of a skinable client-side application;
storing the array in the data store;
responsive to a use of the skin on the application, establishing a data connection between the data store and the application; and
updating the array to reflect the use of the skin.

2. The method of claim 1 further comprising the steps of:
aggregating a plurality of arrays which reflect the use of the skin; and
resolving a common demographic profile associated with the skin.

3. The method of claim 1 further comprising the steps of sending demographically targeted content to the application responsive to the use of the skin.

4. The method of claim 1 further comprising:
establishing a conference system, the system having a plurality of conference areas;
establishing a conference feature communicatively coupled to the application;
associating at least one predetermined conference area with the use of the skin.

5. The method of claim 4, further comprising the step of defaulting to the at least one predetermined conference area responsive to an execution of the conference feature and the use of the skin.

6. A method of obtaining demographic information relating to the use of a distributable skin, the method comprising the steps of:
establishing a client-side skin monitoring application adapted to detect the presence of at least one skin on a client-side computing device;
establishing a demographic data store communicatively coupled to the client-side skin monitoring application;
establishing an identity of at least one skin on the client-side computing device through the client-side skin monitoring application; and
transmitting the identity of the at least one skin to the demographic data store.

7. The method of claim 6 wherein the at least one skin is enabled on a third-party skinable application.8. The method of claim 6 further comprising the step of monitoring internal operating system messaging to detect the presence of the at least one skin.

8. The method of claim 6 further comprising the step of scanning at least one client-side storage device to detect the presence of the least one skin.

9. The method of claim 9 further comprising the step of preselecting an array of file directories to scan for the at least one skin.

10. A method of obtaining anonymous demographic information relating to the use of a distributable skin, the method comprising the steps of:
establishing a demographic data store;
retrieving an anonymous identifier responsive to the registration of a skinable client-side application;
storing the anonymous identifier in the data store;
responsive to a use of the skin on the application, establishing a data connection between the data store and the application; and
updating the anonymous identifier to reflect the use of the skin.

11. The method of claim 11 further comprising the steps of:
predefining a demographic profile for the skin based on the aesthetic qualities of the skin; and
associating the demographic profile with the anonymous identifier.

12. The method of claim 11 further comprising the steps of sending demographically targeted content to the application responsive to the use of the skin.

13. The method of claim 11 further comprising:
establishing a conference system, the system having a plurality of conference areas;
establishing a conference feature communicatively coupled to the application;
associating at least one predetermined conference area with the use of the skin; and
The method of claim of 14, further comprising the step of defaulting to the at least one predetermined conference area responsive to an execution of the conference feature and the use of the skin.

14. A method of authoring a skin with embedded demographic information, the method comprising:
establishing a predetermined specification for arranging an array of content media encapsulated within the skin;
establishing a intended demographic target of the skin based on the array of content media;
associating a remotely retrievable identifier with the intended demographic target; and
storing the identifier in the skin.

15. The method of claim 16 further comprising the step of embedding intellectual property rights data into the skin.

16. A computer program product authoring a skin file with embedded demographic information comprising:
a computer-readable medium;
an authoring module stored on the medium, that arranges an array of content media according to a predetermined specification of the skin; and
a demographic profile module communicatively coupled to the authoring module to store an identifier associated with an intended demographic target of the skin based on the array of content media.

17. The computer program product of claim 18 further comprising a digital rights module communicatively coupled to the authoring module to embed intellectual property rights data into the skin file. A method of obtaining demographic information relating to the use of a distributable skin, the method comprising the steps of:
establishing a demographic data store;
retrieving an array of demographic information responsive to the registration of a skinable client-side application;
storing the array in the data store;
responsive to a use of the skin on the application, establishing a data
connection between the data store and the application;
updating the array to reflect the use of the skin;
sending demographically targeted content to the application responsive to the use of the skin;
aggregating a plurality of arrays which reflect the use of the skin; and
resolving a common demographic profile associated with the skin.
